(19) United States
(12) Patent Application Publication
(10) Pub. No.: US 2014/0149559 A1
(43) Pub. Date: May 29, 2014

(54) VIRTUAL PRIVATE NETWORK (VPN) SYSTEM UTILIZING CONFIGURATION MESSAGE INCLUDING VPN CHARACTER CONFIGURATION STRING

(71) Applicant: Inside Secure, Meyreuil (FR)

(72) Inventors: Kimmo Kari Petteri Parviainen-Jalanko, Espoo (FI); Leena Kaija Pohja, Tuusula (FI)

(73) Assignee: Inside Secure, Meyreuil (FR)

(21) Appl. No.: 14/091,744

(22) Filed: Nov. 27, 2013

Related U.S. Application Data
(60) Provisional application No. 61/731,327, filed on Nov. 29, 2012.

(51) Int. Cl. G06F 15/177

(52) U.S. Cl. CPC G06F 15/177
USPC 709/220

(57) ABSTRACT

A virtual private network (VPN) system may include a VPN server configured to generate a configuration message comprising a VPN character configuration string, and a VPN client device configured to receive the configuration message and initiate a VPN connection with the VPN server over a communications network based upon the VPN character configuration string. The VPN server may be configured to provide the configuration message to the VPN client device in a non-human-readable form, and the VPN client device may be configured to initiate the VPN connection without user entry of VPN configuration data.

### TECHNICAL FIELD

This application relates to communications networks and, more particularly, to virtual private networks (VPNs) and related methods.

### BACKGROUND

A virtual private network (VPN) may be used to extend private network resources across a public network, such as the Internet. In a VPN, a VPN connection is established which allows a host computer to send and receive data across a public network just as if the public network was private. This allows the functionality, security and management policies of the private network to be maintained despite the intervening public network.

VPN configuration generally involves a relatively large set of parameters that have to be defined to be able to form a VPN connection. Some parameters may be negotiable depending on server settings, but regardless, part of the configuration is entered by the client user. In the case where the client is in a mobile device, entering VPN configuration details by hand may be cumbersome if not prohibitively difficult for users. Also, manual configuration may be prone to human error, especially when entering IPv6 addresses, or passwords and such containing special characters, for example.

Typically, proprietary VPN configuration formats are used, and the configuration data is either shared as files or entered via graphical user interface. Reducing the number of configurable parameters may be attempted by using default parameter sets.

One example approach for VPN configuration is the QuickSec®/IPsec Client Toolkit from Inside Secure. QuickSec®/IPsec enables developers to build robust IPsec VPN client functionality into mobile and remote networking devices. QuickSec®/IPsec is a small-footprint security toolkit which supports mobile VPN standards and platforms, including the IPsec mobility and multi-homing protocol MOBIKE, as well as mobile platforms such as Android, various embedded Linux and Windows Mobile.

### SUMMARY

A virtual private network (VPN) system may include a VPN server configured to generate a configuration message comprising a VPN character configuration string, and a VPN client device configured to receive the configuration message and initiate a VPN connection with the VPN server over a communications network based upon the VPN character configuration string. The VPN server may be configured to provide the configuration message to the VPN client device in a non-human-readable form, and the VPN client device may be configured to initiate the VPN connection without user entry of VPN configuration data.

More particularly, the VPN character configuration string may include a VPN platform scheme identifier. The VPN character configuration string may also include at least one character specifying at least one of a format and an encoding type for the configuration message. Furthermore, the VPN character configuration string may include at least one flag specifying a VPN client implementation setting. The VPN character configuration string may also include an Internet Protocol Security (IPSec) algorithm identifier, or an Internet Key Exchange (IKE) algorithm identifier. Moreover, the VPN character configuration string may include at least one of an address field, a VPN secret field, and a password field.

By way of example, the configuration message may comprise a short message service (SMS) message. In accordance with another example, the configuration message may comprise a quick response (QR) code. The VPN client device may comprise a mobile wireless communications device, for example. Also by way of example, the VPN server may comprise a network access server (NAS).

A related VPN configuration method comprising may include generating a configuration message including a VPN character configuration string in a non-human-readable form at a VPN server, and providing the configuration message to a VPN client device. The method may further include receiving the configuration message at the VPN client device, and initiating a VPN connection from the VPN client device to the VPN server over a communications network based upon the VPN character configuration string and without user entry of VPN configuration data at the VPN client device.

A related VPN client device may include an input device configured to receive a configuration message comprising a VPN character configuration string in a non-human-readable form from a VPN server. The VPN client device may also include a processor coupled with the input device and configured to initiate a VPN connection with the VPN server over a communications network based upon the VPN character configuration string, and without user entry of VPN configuration data at the VPN client device.

A related non-transitory computer-readable medium may have computer-executable instructions for causing a VPN client device to perform various steps. The steps may include receiving a configuration message comprising a VPN character configuration string in a non-human-readable form from a VPN server, and initiating a VPN connection with the VPN server over a communications network based upon the VPN character configuration string and without user entry of VPN configuration data at the VPN client device.

### BRIEF DESCRIPTION OF THE DRAWINGS

FIG. 1 is a schematic block diagram of a virtual private network (VPN) system in accordance with an example embodiment.

FIG. 2 is a flow diagram illustrating method aspects associated with the VPN system of FIG. 1.

FIG. 3 is a front view of the client device of FIG. 1 illustrating an example approach for automatic VPN configuration.

FIG. 4 is a front view of an alternative embodiment of the client device of FIG. 1 using another example approach for automatic VPN configuration.

FIG. 5 is a schematic diagram of an example embodiment of the VPN client device shown in FIG. 1.

### DETAILED DESCRIPTION

The present description is made with reference to example embodiments. However, many different embodiments may be used, and thus the description should not be construed as limited to the embodiments set forth herein. Rather, these embodiments are provided so that this disclosure will be thorough and complete. Like numbers refer to like elements throughout, as prime notation is used to indicate similar elements in different embodiments.

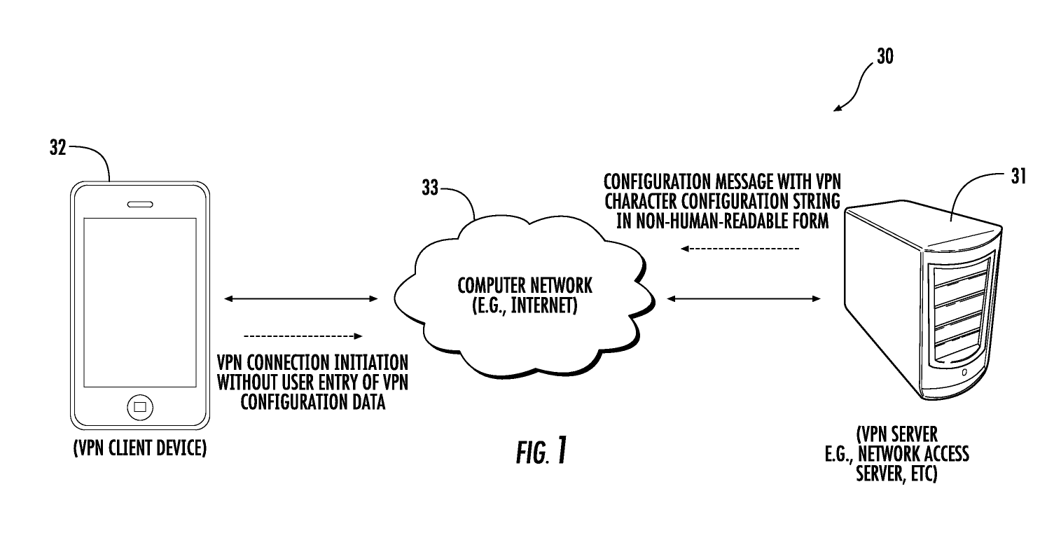

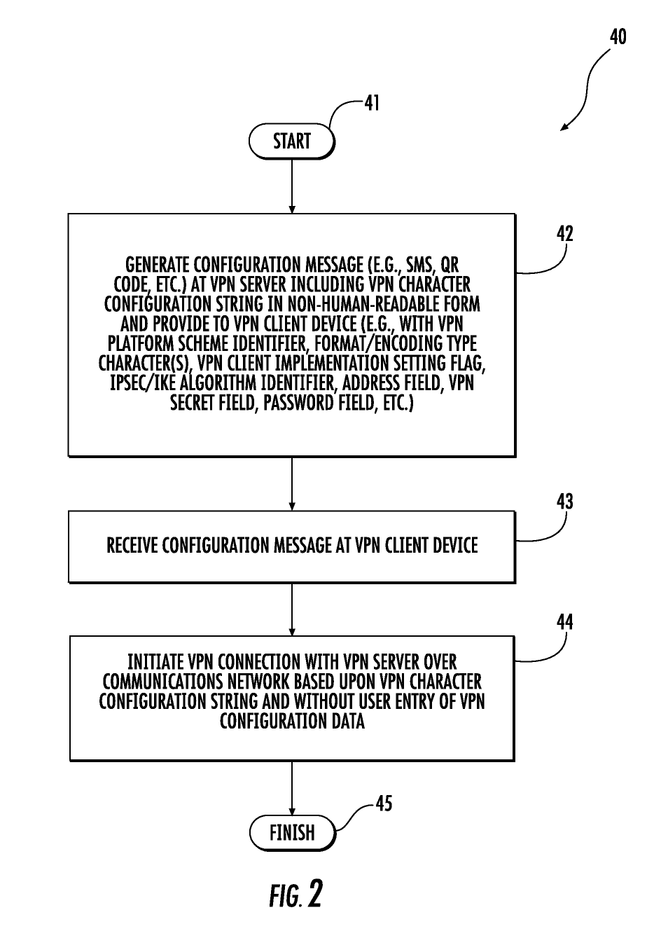

Referring initially to FIGS. 1 and 2, a virtual private network (VPN) system 30 and associated method aspects are first described. The system 30 illustratively includes a VPN server 31, one or more VPN client devices 32, and a computer network 33 over which the VPN server and VPN client device(s) establish a VPN. By way of example, the VPN server 31 may be a network access server (NAS), media gateway, remote access server (RAS), etc. In the illustrated example, the VPN client device 32 is a mobile communications device (i.e., a smart phone), but it will be appreciated that other suitable VPN client devices may also be used (e.g., desktop or laptop computers, tablet computers, etc.). As described above, the computer network 32 over which the VPN is established is typically a public or shared network, such as the Internet, for example.

Beginning at Block 41 of the flow diagram 40, the VPN server 31 may be configured to generate a configuration message including a VPN character configuration string, at Block 42, which may be in a non-human-readable form, as will be discussed further below. The VPN client device 32 may be configured to receive the configuration message, at Block 43, and initiate a VPN connection with the VPN server 31 over the communications network 33 based upon the VPN character configuration string, and without user entry of VPN configuration data at the VPN client device (Block 44), which concludes the method illustrated in FIG. 2 (Block 45).

More particularly, in the example approach, VPN configuration may be performed using a set of type-value attribute pairs. The type-value attribute pairs may have the following properties:
attribute pairs may be dependent on each other, and thus either have reduced set of possible values or only exist depending on the value of the former attribute; and
standards and implementation parameters may define format constraints per attribute type.
   Using these properties, as well as a one or more encoding methods (or combination thereof), the configuration attributes may be compressed into a compact character string format message, which may be passed to the VPN client device 32 via an SMS message, or in a bar code such as QR code.

More particularly, on-off selections in VPN configuration attributes may be encoded as a bitmask, for example, thus allowing them to fit in one or two bytes. The value of the flags defining the authentication type may then, in turn, govern the presence of the shared secret. The gateway IP address length may be determined based upon the value of IPv6 flag, and so forth. The final binary string may then be encoded to a compact character string using various encoding methods. The encoding method selection may be optimized for the message transport method, depending on the supported character set, and the first byte of the message may be used as a marker to indicate the encoding method.

This mechanism for configuration may be used for conveying the entire configuration data, or just a part of it. For example, the shared secret may be sent in the encoded configuration string by itself, to help reduce plain text exposure in an unprotected network.

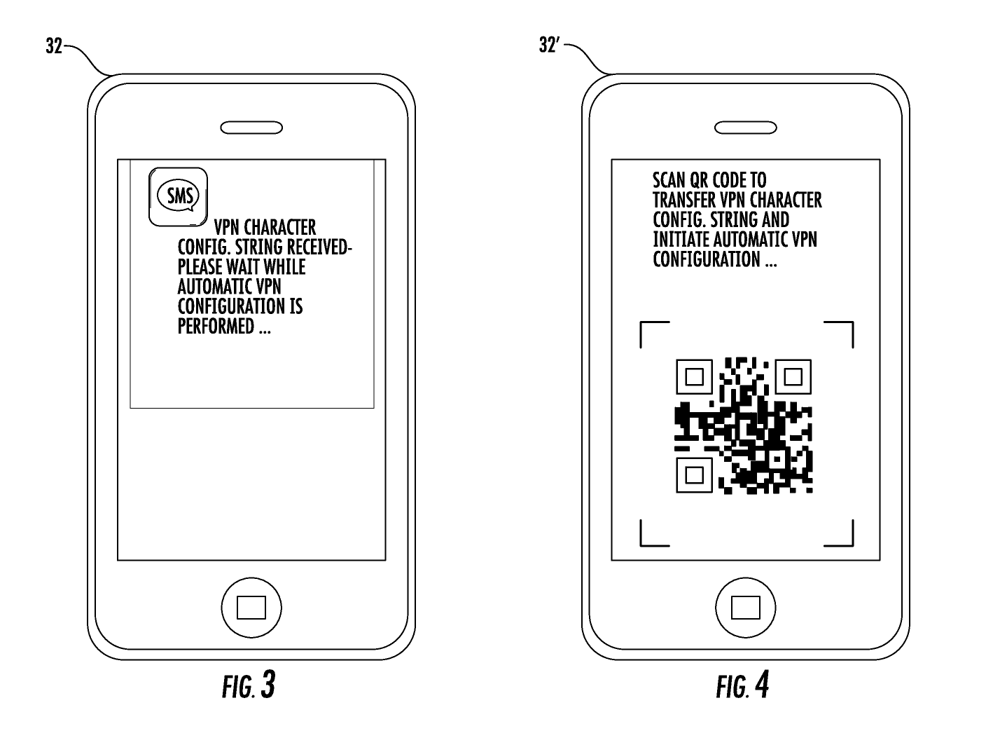

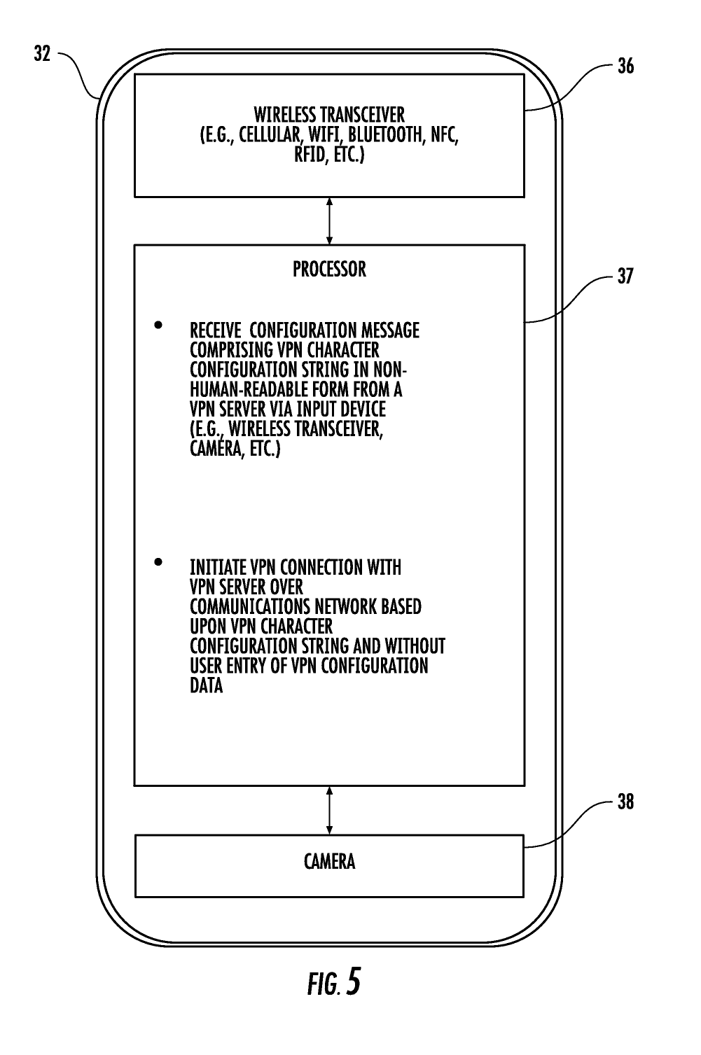

Thus, rather than requiring a cumbersome manual configuration, or a mechanism based on downloading a configuration file (e.g., from an email attachment), the VPN configuration may be passed to the client using mechanisms already available in a mobile device, etc., without any further settings or additional tools. For example, a mobile phone with a UICC card including a SIM compliant application may receive an SMS message including a configuration character string (see FIG. 3). Moreover, some smartphone platforms offer bar or quick response (QR) code reading in combination with a camera device (see FIG. 4). Furthermore, QR codes support native encryption, and the configuration string may also be encrypted accordingly to reduce the vulnerability caused by exposing the configuration via an unprotected network. Also, the configuration need not be passed via a human-readable form, thus decreasing the possibility of someone gaining the knowledge of shared secrets, for example. The above-described approach may be implemented by a mobile device vendor via a VPN client application, a corporate information technology (IT) support providing a VPN configuration, etc. One example VPN solution in which the above-described techniques may be implemented is the above-described QuickSec®/IPsec toolkit, although it may be used with other platforms (e.g., iOS, Windows, etc.) as well.

The foregoing will be further understood with reference to a sample message format which may be used to communicate a character configuration string, although it will be appreciated that other message formats may also be used.

### Sample Message:

<vpn:><0><F><AAAA><G><T[L][value]> . . . [T[L][value]][t0]
In the sample message, the first five bytes of the message are sent with the native encoding of the transport method, and the components of the message are as follows:
“vpn:”—4 bytes
This is the scheme identifier for the platform to detect the application to be used.
   “0”—1 byte
This is a case insensitive alphanumeric character to specify the format and encoding of the subsequent message. This byte may also provide forward compatibility for additional identifiers or codes used for future implementations. This is the first byte of the actual configuration data.
   The following fields are encoded using an encoding scheme specified by the 5th (1st) byte of the message, and after decoding they hold the following data:
   “F”—1 byte
These are flags to define various “on/off” settings. Current VPN client implementations use 6 or 7. Some flags may be reused based on other flags (e.g., aggressive mode may be valid for IKEv1 and Mobile may be valid for IKEv2).
   “AAAA”—4 bytes
These are for encryption and authentication algorithms for IKE and IPSec.
   “G”—1 byte

This is a Diffie-Hellman group used for IKE.

“T[L](value]”—1 byte+optional 1 byte+variable number of bytes
These are fields for various addresses, names and secrets/password. Some types (such as “identity (e-mail)” and “gateway address (fqdn)”) may be compressed further because of the reduced size of the character set to be usable. Also, some attributes are fixed length and the length field may be omitted. It is possible to just specify a type (such as use IP address as IKE identifier).
   “t0”—1 byte (optional)
This is a type code 0, Null byte (‘\x00’) to indicate the end of message if the underlying transport mechanism does not specify the message length.

Referring additionally to FIG. 5, the VPN client device 32 may include appropriate hardware (e.g., processor 37, etc.) and a non-transitory computer-readable medium including computer-executable instructions for performing the various operations described above. More particularly, the steps may include receiving a configuration message comprising a VPN character configuration string in a non-human-readable form from the VPN server 31, and initiating a VPN connection with the VPN server over a communications network based upon the VPN character configuration string, and without user entry of VPN configuration data at the VPN client device. The VPN client deice 32 illustratively includes various input devices, such as a wireless transceiver 36 (e.g., cellular, WiFi, Bluetooth, NFC, RFID, etc.) and a camera 38 (e.g., for QR or bar code reading), for receiving the configuration message, as described further above. Other suitable input devices may also be used, as will be appreciated by those skilled in the art.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A virtual private network (VPN) system comprising:
a VPN server configured to generate a configuration message comprising a VPN character configuration string; and
a VPN client device configured to receive the configuration message and initiate a VPN connection with said VPN server over a communications network based upon the VPN character configuration string;
said VPN server being configured to provide the configuration message to said VPN client device in a non-human-readable form, and said VPN client device being configured to initiate the VPN connection without user entry of VPN configuration data.

2. The VPN system of claim 1 wherein the VPN character configuration string includes a VPN platform scheme identifier.

3. The VPN system of claim 1 wherein the VPN character configuration string includes at least one character specifying at least one of a format and an encoding type for the configuration message.

4. The VPN system of claim 1 wherein the VPN character configuration string includes at least one flag specifying a VPN client implementation setting.

5. The VPN system of claim 1 wherein the VPN character configuration string includes an Internet Protocol Security (IPSec) algorithm identifier.

6. The VPN system of claim 1 wherein the VPN character configuration string includes an Internet Key Exchange (IKE) algorithm identifier.

7. The VPN system of claim 1 wherein the VPN character configuration string includes at least one of an address field, a VPN secret field, and a password field.

8. The VPN system of claim 1 wherein the configuration message comprises a short message service (SMS) message.

9. The VPN system of claim 1 wherein the configuration message comprises a quick response (QR) code.

10. The VPN system of claim 1 wherein said VPN client device comprises a mobile wireless communications device.

11. The VPN system of claim 1 wherein said VPN server comprises a network access server (NAS).

12. A virtual private network (VPN) configuration method comprising:
generating a configuration message comprising a VPN character configuration string in a non-human-readable form at a VPN server, and providing the configuration message to a VPN client device;
receiving the configuration message at the VPN client device; and
initiating a VPN connection from the VPN client device with said VPN server over a communications network based upon the VPN character configuration string and without user entry of VPN configuration data at the VPN client device.

13. The method of claim 12 wherein the VPN character configuration string includes a VPN platform scheme identifier.

14. The method of claim 12 wherein the VPN character configuration string includes at least one character specifying at least one of a format and an encoding type for the configuration message.

15. The method of claim 12 wherein the VPN character configuration string includes at least one flag specifying a VPN client implementation setting.

16. The method of claim 12 wherein the VPN character configuration string includes an Internet Protocol Security (IPSec) algorithm identifier.

17. The method of claim 12 wherein the VPN character configuration string includes an Internet Key Exchange (IKE) algorithm identifier.

18. The method of claim 12 wherein the VPN character configuration string includes at least one of an address field, a VPN secret field, and a password field.

19. The method of claim 12 wherein the configuration message comprises a short message service (SMS) message.

20. The method of claim 12 wherein the configuration message comprises a quick response (QR) code.

21. A virtual private network (VPN) client device comprising:
an input device configured to receive a configuration message comprising a VPN character configuration string in a non-human-readable form from a VPN server; and
a processor coupled with said input device and configured to initiate a VPN connection with the VPN server over a communications network based upon the VPN character configuration string and without user entry of VPN configuration data at the VPN client device.

22. The VPN client device of claim 21 wherein the VPN character configuration string includes a VPN platform scheme identifier.

23. The VPN client device of claim 21 wherein the VPN character configuration string includes at least one character specifying at least one of a format and an encoding type for the configuration message.

24. The VPN client device of claim 21 wherein the VPN character configuration string includes at least one of an Internet Protocol Security (IPSec) algorithm identifier and an Internet Key Exchange (IKE) algorithm identifier.

25. A non-transitory computer-readable medium having computer-executable instructions for causing a virtual private network (VPN) client device to perform steps comprising:
receiving a configuration message comprising a VPN character configuration string in a non-human-readable form from a VPN server; and
initiating a VPN connection with the VPN server over a communications network based upon the VPN character configuration string and without user entry of VPN configuration data at the VPN client device.

26. The non-transitory computer-readable medium of claim 21 wherein the VPN character configuration string includes a VPN platform scheme identifier.

27. The non-transitory computer-readable medium of claim 21 wherein the VPN character configuration string includes at least one character specifying at least one of a format and an encoding type for the configuration message.

28. The non-transitory computer-readable medium of claim 21 wherein the VPN character configuration string includes at least one of an Internet Protocol Security (IPSec) algorithm identifier and an Internet Key Exchange (IKE) algorithm identifier.
